(19) United States
(12) Patent Application Publication
(10) Pub. No.: US 2022/0274897 A1
(43) Pub. Date: Sep. 1, 2022

(54) SUGAR ALCOHOL-BASED MICRONUTRIENT DISPERSION

(71) Applicant: NANOCHEM SOLUTIONS, INC., Bedford Park, IL (US)

(72) Inventors: George MURRAY, Lebanon, IN (US); Fan GRACE, Naperville, IL (US); Joseph FAN, Naperville, IL (US)

(21) Appl. No.: 17/612,117

(22) PCT Filed: May 18, 2020
(86) PCT No.: PCT/US20/33427

§ 371 Date: Nov. 17, 2021

Related U.S. Application Data
(60) Provisional application No. 62/849,837, filed on May 17, 2019.

(51) Int. Cl. C05G 5/30; C05D 9/02; C05C 9/00

(52) U.S. Cl. CPC C05G 5/30; C05D 9/02; C05C 9/005; C05C 11/00

(57) ABSTRACT

A sugar alcohol micronutrient dispersion, with or without a thermal potassium, sodium, and/or ammonium polyaspartate (TPA) component, that uniformly applies micronutrients to granular fertilizers, without or without a nitrification inhibitor, 3-4-dimethylpyrazole phosphate.

### CROSS-REFERENCE TO RELATED APPLICATION

This patent application claims priority to U.S. Provisional Application 62/849,837 filed May 17, 2019, the disclosure of which is considered part of the disclosure of this application and is hereby incorporated by reference in its entirety.

### FIELD OF THE INVENTION

The present invention relates generally to the field of fertilizers. More specifically, the present invention relates to a fertilizer product that is applied to granular fertilizer products as a coating. Because soils are often deficient in micronutrients (boron, cobalt, copper, iron, manganese, molybdenum, nickel, and zinc), it can be advantageous to apply micronutrients at the same time on a macronutrient (nitrogen, phosphorus, potassium, calcium, magnesium, and sulfur) granular fertilizer application.

### BACKGROUND

In the agriculture and lawn management industry, it is common for growers to use a variety of granular fertilizers containing primarily nitrogen, phosphorous, and potassium at the time of planting, or in some cases as a side dress while the crops are currently growing. In some instances, the practice entails placing the fertilizer into the seed row directly with the seed. This is done to enhance the germination rate and success of the seed, and aid in the overall development of the plant by applying essential nutrients in close proximity to the soil. While nitrogen, phosphorus, and potassium (in varying forms) often can aid in the germination of the seed, micronutrients are often essential for a successful germination and growth of the seed and plant respectively. Boron is essential for the development of cell walls. Cobalt enhances the nodulation of legumes. Copper, among other things, is necessary for the synthesis of lignin and defense compounds. Iron is essential for the synthesis of chlorophyll. Manganese is essential for the development of the thylakoid membranes (within chlorophyll), and the development of defense compounds. Molybdenum is essential for the oxidization of nitrate into nitrite, and thereby making nitrate usable in the plant. Nickel assists in the catalysis of urea in plants, forming ammonia and carbon dioxide. Finally, zinc is a component of over 300 different enzymes, and assists in the development of the rooting hormone, indole-3-acetic acid (IAA).

To address both the need of micronutrients in the field, and the necessity to reduce labor inputs, and provide a granular product with both varying amounts of nitrogen, phosphorus, and potassium, as well as select micronutrients, manufacturers have employed a variety of different strategies. These strategies range from aqueous and oil-based micronutrient dispersions that are sprayed onto granular fertilizers to micronutrient granular products that are blended into the nitrogen, phosphorus, and/or potassium granular product. The issue with the latter is a lack of uniformity of the micronutrient application when the granular products are spread out into the field. Often the granular micronutrient component is only 2-6% of the entire granular blend. To combat this, one manufacturer sprays an acid on the granular blend, and then applies a micronized powder form of the micronutrient to the granular fertilizer. (U.S. Pat. No. 8,221,515 B2). This has drawbacks after the product is bagged, and as the product is palletized. Weight on the bag and shifting within the bags can cause the powder to loosen from the granular fertilizer, leading to waste via dust in the bags. Regarding aqueous-based micronutrient dispersions, blenders are often limited with the amount of spray volume they can apply to the often-hygroscopic granular nitrogen, phosphorus, and/or potassium blends. In regard to the oil-based micronutrient dispersions, blenders are left with an oil-based product that often has questionable environmental benefits once applied to the field. Beneficial bacteria and fungi in the field—organisms that can assist with the increase in the availability of the applied micronutrients to plants—are programmed to use water-soluble carbon-based forms of nutrition, as opposed to oil based.

The existing art is all compromised in some way: Oil based products satisfy dust control and proper micronutrient levels but do not enhance the general soil biome; water-based products are friable in storage and transport while not supporting general soil biology and often cannot be applied in the optimal amounts without rendering the fertilizer tacky and difficult to apply.

Clearly there exists a need to apply micronutrients to granular fertilizers uniformly that effectively eliminates the issue of dust, the issue of the hygroscopic nature of the granular fertilizer, and provides a food source for the biology in the soil that increases the uptake efficiency of the micronutrients into the plants.

### BRIEF SUMMARY OF THE INVENTION

In one aspect, this disclosure is related to sugar alcohol-based micronutrient dispersion composition for application to a fertilizer granule comprising a sugar-alcohol component; one or more metal components; an anionic dispersant component; and an anionic surfactant component.

In another aspect, this disclosure is related to compositions of a new sugar alcohol-based micronutrient dispersion, with or without a salt component, which can include but is not limited to a thermal polyaspartate salt (sodium, potassium, ammonium, or otherwise) (TPA) or thermal polyaspartic acid component, that uniformly applies micronutrients to granular fertilizers. According to an aspect of the present disclosure, there is provided a dispersion product comprising from about 25-50% by weight of a sugar alcohol component, from about 1-65% by weight of a micronutrient metals and/or metalloids component, from about 5-10% water by weight, from about 0.25%-2% by weight of an anionic dispersant, from about 0.25%-2% by weight of an anionic surfactant, from about 0.1%-0.5% by weight of a rheology modifier that increases viscosity, and about 0-25% by weight of a sodium, potassium, ammonium, other polyaspartate salt or other salt.

In another aspect, this disclosure is related to a method of manufacturing and applying a sugar-alcohol based micronutrient dispersion to a fertilizer granule.

The invention now will be described more fully hereinafter with reference to the accompanying drawings, which are intended to be read in conjunction with both this summary, the detailed description and any preferred and/or particular embodiments specifically discussed or otherwise disclosed. This invention may, however, be embodied in many different forms and should not be construed as limited to the embodiments set forth herein; rather, these embodiments are provided by way of illustration only and so that this disclosure will be thorough, complete and will fully convey the full scope of the invention to those skilled in the art.

### DETAILED DESCRIPTION OF THE INVENTION

The following detailed description includes references to the accompanying drawings, which forms a part of the detailed description. The drawings show, by way of illustration, specific embodiments in which the invention may be practiced. These embodiments, which are also referred to herein as “examples,” are described in enough detail to enable those skilled in the art to practice the invention. The embodiments may be combined, other embodiments may be utilized, or structural, and logical changes may be made without departing from the scope of the present invention. The following detailed description is, therefore, not to be taken in a limiting sense.

Before the present invention of this disclosure is described in such detail, however, it is to be understood that this invention is not limited to particular variations set forth and may, of course, vary. Various changes may be made to the invention described and equivalents may be substituted without departing from the true spirit and scope of the invention. In addition, many modifications may be made to adapt a particular situation, material, composition of matter, process, process act(s) or step(s), to the objective(s), spirit or scope of the present invention. All such modifications are intended to be within the scope of the disclosure made herein.

Unless otherwise indicated, the words and phrases presented in this document have their ordinary meanings to one of skill in the art. Such ordinary meanings can be obtained by reference to their use in the art and by reference to general and scientific dictionaries.

References in the specification to “one embodiment” indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

The following explanations of certain terms are meant to be illustrative rather than exhaustive. These terms have their ordinary meanings given by usage in the art and in addition include the following explanations.

As used herein, the term “and/or” refers to any one of the items, any combination of the items, or all of the items with which this term is associated.

As used herein, the singular forms “a,” “an,” and “the” include plural reference unless the context clearly dictates otherwise.

As used herein, the terms “include,” “for example,” “such as,” and the like are used illustratively and are not intended to limit the present invention.

As used herein, the terms “preferred” and “preferably” refer to embodiments of the invention that may afford certain benefits, under certain circumstances. However, other embodiments may also be preferred, under the same or other circumstances.

Furthermore, the recitation of one or more preferred embodiments does not imply that other embodiments are not useful and is not intended to exclude other embodiments from the scope of the invention.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element without departing from the teachings of the disclosure.

Unless defined otherwise, all technical and scientific terms used herein have the same meaning as commonly understood by one of ordinary skill in the art in which the invention belongs. Although any methods and materials similar or equivalent to those described herein can be used in the practice or testing of the present invention, the preferred methods and materials are now described. All publications mentioned hereunder are incorporated herein by reference.

In some exemplary embodiments of the present disclosure, a micronutrient dispersion composition can be created including a sugar-alcohol component, one or more metal or metalloid components, an anionic dispersant component, and an anionic surfactant component. The micronutrient dispersion can optionally include a salt component, including but not limited to a polyaspartate salt or a thermal polyaspartate salt. Additionally, some embodiment of the micronutrient dispersion may further include a dimethylpyrazole source. In some exemplary embodiments, the micronutrient dispersion can be applied to and coat a granule. The granules can then be applied to an environment to provide fertilizer and aid in the uptake of micronutrients for plants surrounding the environment.

According to one exemplary embodiment of the present disclosure, a sugar alcohol-based micronutrient dispersion, with or without a thermal potassium, sodium, and/or ammonium polyaspartate (TPA) component, that can be uniformly applied to granular fertilizers or granular components. According to an aspect of the present disclosure, a micronutrient dispersion product can about 25-50% by weight of a sugar alcohol component, from about 1-65% by weight of a micronutrient metals and/or metalloids component, from about 5-10% water by weight, from about 0.25%-2% by weight of an anionic dispersant, from about 0.25%-2% by weight of an anionic surfactant, from about 0.1%-0.5% by weight of a rheology modifier that increases viscosity, and about 0-25% by weight of a sodium, potassium, ammonium, other polyaspartate salt or other salt. In some exemplary embodiments, the micronutrient dispersion can have e a specific gravity of about 1.3 to about 1.8 or about 1.4 to about 1.7, and a viscosity of between about 3000-9000 cP at room temperature. In some exemplary embodiments, the micronutrient dispersion can optionally include a dimethylpyrazole source. The dimethylpyrazole source can be included in the micronutrient dispersion from about 0-20% by weight.

Various micronutrients, such as boron, manganese, and zinc as a coating on nitrogen, phosphorus, and/or potassium fertilizers can aid in the early season growth characteristics of crops. Additionally, applications of lower levels of specific sugar alcohols can enhance the community-level physiological profile, leading to an increase in enzyme activities of the bacteria in the soil. This increase in enzyme activity, and overall functioning of the bacteria in the soil, can lead to an increase in the efficiency of the availability of the micronutrients. Sugar alcohols, while being a benefit to the biology in the soil, serve as an excellent substitute to water in a micronutrient dispersion for granular fertilizer as they will not only not contribute to the solubilization of the granular fertilizer (and the eventually break down the structure in a bagged environment), but also dry in the form of a harder shell—which will actually increase the stability of the granular structure in a bagged environment. Because of this, the dustiness often attributed to granular fertilizer is greatly reduced when sprayed with a sugar alcohol-based dispersion.

Thermal polyaspartates (and other poly-amino polymers, such as polyglutamate, polylysine, polyarginine, etc.), polymaleic acid, and other polymers and copolymers containing a monomer with at least one carboxylic acid group have great use in micronutrient formulae. In soil, these polymers, can slow the formation of crystal embryos comprised of positive and negative ions present in the soil or added to the soil in the form of primary, secondary, and micronutrient fertilizers. Slowing the natural formation of crystals containing nutrients the plant requires reduces the energy expenditure the plant must make to break crystals and obtain nutrients. The polymers of the present disclosure can also contribute to dust control and shell coating strength and because they biodegrade throughout the growing season, the degradation products become slowly available as a food source for the soil biome.

In some exemplary embodiments of the present disclosure, the composition for a salt component can include, but by no means limited to the following: sodium polyaspartate, potassium polyaspartate, ammonium polyaspartate, sodium polymaelate, ethanolamine polyaspartate, potassium polymaleate, ammonium polymaleate, polylysine, polyarginine, sodium polyglutamate, potassium polyglutamate, ammonium polyglutamate, polyglycine, polycitrate salts, and mixtures thereof.

In some exemplary embodiments, the composition can additionally include a dimethylpyrazole source. A dimethylpyrazole source can include but is not limited to 3,4-dimethylpyrazole phosphate, 3,4-dimethylpyrazole sulfate, 3,4-dimethylpyrazole nitrate, 3,4-dimethylpyrazole chloride, 3,4-dimethylpyrazole succinate, 3,4-dimethylpyrazole aspartate, 3-4-dimethylpyrazole polyaspartate, 3,5-dimethylpyrazole.

The sugar-alcohol source can be any suitable source, including but not limited to be glycerol, erythritol, arabitol, xylitol, ribitol, mannitol, sorbitol, galatifol, fucitol, iditol, inositol, volemitol, isomalt, maltitol, lactitol, maltotriitol, maltotetraitol, polyglycitol, and mixtures thereof.

One or more metal or metalloid micronutrient sources can be included in the dispersion, which can include metals such as boron, cobalt, copper, iron, manganese, molybdenum, nickel, zinc, and other metals and metal/metalloid compounds.

A boron source may be for example, but by no means limited to: boric acid, potassium tetraborate (and its respective hydrates), sodium tetraborate (and its respective hydrates), copper borate, ferric (and ferrous) borate, manganese borate, zinc borate, magnesium borate, calcium borate, boron-amino acid chelates, and mixtures thereof.

A cobalt source may be for example, but by no means limited to: cobalt oxide, cobalt hydroxide, cobalt carbonate, cobalt sulfate, cobalt chloride, cobalt nitrate, cobalt EDTA, cobalt DTPA, cobalt EDDS, cobalt IDS, cobalt citrate, cobalt-amino acid chelates, and mixtures thereof.

A copper source may be for example, but by no means limited to: copper (I) oxide, copper (II) oxide, copper hydroxide, copper carbonate, copper sulfate (and its respective hydrates), copper chloride, copper nitrate, copper EDTA, copper DTPA, copper EDDS, copper IDS, copper citrate, copper-amino acid chelates, and mixtures thereof.

An iron source may be for example, but by no means limited to: iron (II) oxide, iron (III) oxide, iron (II, III) oxide, iron (II) hydroxide, iron (III) hydroxide oxide, iron (II) carbonate, iron (II) sulfate, iron (III) sulfate, iron (II) chloride, iron (III) chloride, iron (III) nitrate, iron EDTA, iron DTPA, iron HEDTA, iron EDDHA, iron EDDS, iron IDS, iron citrate, iron-amino acid chelates, and mixtures thereof.

A manganese source may be for example, but by no means limited to: manganese (II) oxide, manganese (II) hydroxide, manganese (II) carbonate, manganese sulfate, manganese chloride, manganese nitrate, manganese EDTA, manganese DTPA, manganese EDDS, manganese IDS, manganese citrate, manganese-amino acid chelates, and mixtures thereof.

A molybdenum source may be for example, but by no means limited to molybdic acid, molybdenum disulfide, molybdenum dioxide, molybdenum trioxide, sodium molybdate, potassium molybdate, ammonium dimolybdate, ammonium heptamolydate, molybdenum-amino acid chelates, and mixtures thereof.

A nickel source may be for example, but by no means limited to: nickel oxide, nickel hydroxide, nickel carbonate, nickel sulfate, nickel chloride, nickel nitrate, nickel EDTA, nickel DTPA, nickel EDDS, nickel IDS, nickel citrate, nickel-amino acid chelates, and mixtures thereof.

A zinc source may be for example, but by no means limited to: zinc oxide, zinc hydroxide, zinc carbonate, zinc sulfate, zinc chloride, zinc nitrate, zinc EDTA, zinc DTPA, zinc EDDS, zinc IDS, zinc citrate, zinc-amino acid chelates, and mixtures thereof.

Anionic dispersant can be any suitable material and in some exemplary embodiments can be an anionic polymer. In some exemplary embodiments, the anionic polymer can be 1000 g/mol to 100,000 g/mol. Polymers could include be acrylic acid polymers, maleic acid polymers, amino-acid polymers, and phosphonate polymers. Examples would be phosphonobutane-1,2,4-tricarbolyxlic acid, amino-trimethylene phosphonic acid, polyacrylic acid, phosphinopolyacrylic acid, and methylene phosphonic acid.

Anionic surfactants can be any suitable material and can include but are not limited to lauryl-sulfate salts (ammonium, sodium, potassium), laureth-sulfate salts (magnesium, potassium, sodium, etc.), sodium stearate, alkyl sulfates, etc.

Additionally, a rheology modifier or viscosifiers can include but are not limited to xanthan gum, guar gum, sodium alginate, carboxymethyl cellulose, pectin, carrageenan, locust bean gum.

The present disclosure also provides a fertilizer granule that includes a granule component and a coating component. After an exemplary sugar-alcohol composition is formulated, the dispersion can then be applied to a granular material or granular component, which can include fertilizer granules such as urea. Similarly, the granules can be any suitable material and can include nitrogen, phosphorus, potassium, calcium, magnesium, sulfur, or otherwise. The granule material could additionally be clay granules.

The sugar-alcohol micronutrient dispersion can act as a coating component to fully coat a granular component. The coating component can serve multiple purposes which can including increasing the uptake of micronutrients into the plants the fertilizer granule is applied to. The coating component also can aid in decreasing or eliminating any agglomeration between fertilizer granules. The sugar-alcohol micronutrient dispersion can be applied to the granules using any suitable means. In one exemplary embodiment, the sugar-alcohol micronutrient dispersion is sprayed onto a granules at a ratio of about 1:50 to about 1:350, or about 1:100 to about 1:200, or about 1:150 ratio of micronutrient dispersion to granular weight. After the micronutrient dispersion is applied to the granules, the granules can be mixed using any suitable apparatus to fully coat the granules with the micronutrient dispersion. In some exemplary embodiments, a mixing apparatus can continue to mix the micronutrient dispersion until it fully dries to the granules. In some exemplary embodiments, the micronutrient dispersion can include between about 1-5% by weight of boron, 2-10% by weight of manganese, and 4-20% by weight of zinc. Additionally, in some exemplary embodiment after the dispersion has been applied to a granule, the finished coated granules can include between about 0.01-0.05% by weight of boron, 0.02-0.1% by weight of manganese, and about 0.04-0.2% by weight of zinc.

Furthermore, the present disclosure relates to a method for treating soil and/or plants with a micronutrient dispersion. In some exemplary embodiments, the micronutrient dispersion is used to coat a granule. The granule can be a fertilizer granule, including but not limited to urea. The micronutrient dispersion can aid in the uptake of the micronutrients by plants proximate to the soil or other environment to which the dispersion and/or granule is applied.

### EXAMPLES

The following examples provides one or more exemplary embodiments; however, the following embodiments are not intended to limit the possible micronutrient dispersion compositions or fertilizer granule compositions of the present disclosure, nor limit the method of creating or utilizing such compositions.

### Example #1

In some exemplary embodiment, between about 225 and 250 grams of a 99.5% glycerol product is added to about a 500-mL borosilicate glass beaker. In some exemplary embodiments, the glycerol product can have a pH of between 6.5 and 8.5 or about 7 to 8. The glycerol product can then be agitated using any suitable method, such as a standard benchtop mixer with enough RPMs to ensure proper movement of the glycerol. Between about 60 to about 70 grams of water, about 1-2 grams sodium benzoate, about 0.5 to about 1 grams silicon-based defoamer, and about 0.05 to about 0.15 grams xanthan gum can be added to the glycerol, and mixed for about 10 minutes at room temperature. About 120 to about 160 grams of boric acid can then be added to the solution and mixed for 20 minutes. Following this, about 90 to about 110 grams manganese carbonate, and about 100 to about 120 grams of zinc oxide are attached to the mixture and allowed to mix for 5 minutes each. Following this, about 20 to about 40 grams of an anionic liquid dispersant (approximately 30% by weight and about 30,000 g/mol) can be added and mixed for 5 minutes. Following this, about 20 to about 40 grams of a 30% solution of sodium lauryl sulfate is added and mixed for 30 minutes. The finished dispersion can have a specific gravity of about 1.4 to about 1.7, and a viscosity of approximately 3000-9000 cP at room temperature.

### Example #2

In another exemplary embodiment, about 237.9 grams of a 99.5% glycerol product is added to about a 500-mL borosilicate glass beaker. The glycerol product can then be agitated using any suitable method, such as a standard benchtop mixer with enough RPM's to ensure proper movement of the glycerol. Between about 66.4 grams of water, about 1.4 grams sodium benzoate, about 0.7 grams silicon-based defoamer, and about 0.09 grams xanthan gum can be added to the glycerol and mixed for about 10 minutes at room temperature. About 151.5 grams of boric acid is then added to the solution and mixed for 20 minutes. Following this, about 101.9 grams manganese carbonate, and about 112.3 grams of zinc oxide can be added to the mixture and allowed to mix for 5 minutes each. Following this, about 29.5 grams of an anionic liquid dispersant (approximately 30% by weight and about 30,000 g/mol) is added and mixed for 5 minutes. Following this, about 29.5 grams of a 30% solution of sodium lauryl sulfate is added and mixed for about 30 minutes. The finished dispersion has a specific gravity of approximately 1.579, and a viscosity of approximately 3850-5500 cP at room temperature.

### Example #3

The finished composition from example #2 can then added to a spraying apparatus, such as a paint sprayer whereby about 150 grams of the product can be sprayed onto about 50 lbs of urea in a cement mixer. The urea can continue to mix while it dries for 30 minutes. After 30 minutes, the mixer can be shut off, and the finished granule product is a coated urea granule, wherein the coating component includes about 2.0% by weight boron, about 3.4% manganese, and about 6.8% zinc.

### Example #4

Following the same procedure in example #3, about 250 grams of finished product from example #2 is sprayed onto 50 lbs of urea, and mixed for 30 minutes, and then bagged. The granules are completely dry and free from excess moisture that would cause issues of agglomeration in the bag.

### Example #5

In yet another exemplary embodiment of the present disclosure, about 278.8 grams of a 99.5% glycerol product is added to a 500-mL borosilicate glass beaker. Agitation can be provided through any standard benchtop mixer with enough RPMs to ensure proper movement of the glycerol. About 69.3 grams of a 38.0% solution of potassium polyaspartate, about 1.5 grams sodium benzoate, about 0.7 grams silicon-based defoamer can be added and mixed for approximately 10 minutes at room temperature. Next, about 157.5 grams of boric acid can then added to the solution and mixed for about 20 minutes. Following this about 30.8 grams of an anionic liquid dispersant (approximately 30% by weight and about 30,000 g/mol) and mix for 5 minutes. Next, about 101.9 grams manganese carbonate, and about 112.3 grams of zinc oxide are attached to the mixture and allowed to mix for approximately 5 minutes each. The finished dispersion can have a specific gravity of approximately 1.628, and a viscosity of approximately 3800-4500 cP at room temperature.

### Example #6

In yet another exemplary embodiment, about 307.8 grams of 99.5% glycerol product is added to a 500-mL borosilicate glass beaker. Agitation is provided through any standard benchtop mixer with enough RPMs to ensure proper movement of the glycerol. 62.2 grams of reverse-osmosis water is added to decrease the viscosity of the mixture. To further decrease the viscosity, the mix should be heated to approximately 50 degrees Celsius. Once the mix is heated, and the viscosity has sufficiently decreased, add about 336.1 grams of a spray-dried potassium polyaspartate powder that is about 93% active by weight. The potassium polyaspartate powder will slowly go into solution. While the polyaspartate powder is going into solution, about 1.4 grams of sodium benzoate as a preservative can be added. The dispersion can then be mixed for about 1 hour while maintaining the temperature of the mix to at least 50 degrees Celsius. The finished dispersion can have a specific gravity of approximately 1.496, and a viscosity of approximately 8000 cP at room temperature.

### Example #7

Another exemplary embodiment of the micronutrient dispersion can be formed utilizing about 270.4 grams of 99.5% glycerol product that can be added to a 500-mL borosilicate glass beaker. Agitation can be provided through a standard benchtop mixer with enough RPMs to ensure proper movement of the glycerol. About 102.2 grams of reverse-osmosis water can be added to decrease the viscosity of the mixture. About 1.9 grams of defoamer can then added. To further decrease the viscosity, the mix should be heated to approximately 50 degrees Celsius. Once the mix is heated, and the viscosity has sufficiently decreased, about 246.8 grams of a spray-dried potassium polyaspartate powder that is 93% active by weight can be added. The potassium polyaspartate powder will slowly go into solution. While the polyaspartate powder is going into solution, about 1.3 grams of sodium benzoate can be added as a preservative. The mixture can be mixed for about 1 hour while maintaining the temperature of the mix at least 50 degrees Celsius. Once the solution has cooled to around 32 degrees Celsius, about 20.0 grams of 3,4-dimethylpyrazole phosphate can be added. The finished solution has a specific gravity of approximately 1.358 and a viscosity of approximately 4000 cP at room temperature.

While the invention has been described above in terms of specific embodiments, it is to be understood that the invention is not limited to these disclosed embodiments. Upon reading the teachings of this disclosure many modifications and other embodiments of the invention will come to mind of those skilled in the art to which this invention pertains, and which are intended to be and are covered by both this disclosure and the appended claims. It is indeed intended that the scope of the invention should be determined by proper interpretation and construction of the appended claims and their legal equivalents, as understood by those of skill in the art relying upon the disclosure in this specification and the attached drawings.

What is claimed is:

1. A micronutrient dispersion composition for application to a fertilizer granule comprising:
a sugar alcohol component, wherein the sugar alcohol component comprises between 25-50% by weight of the composition;
one or more metal or metalloid components, wherein the metal component comprises between 1-65% by weight of the composition;
an anionic dispersant component, wherein the anionic dispersant component comprises between 0.25-2%% by weight of the composition; and
an anionic surfactant component, wherein the amino surfactant component comprises between 0.25-2%% by weight of the composition.

2. The micronutrient dispersion composition of claim 1 further comprising a rheology modifier component configured to increase viscosity, wherein the rheology modifier comprises between 0.1-5% by weight of the composition.

3. The micronutrient dispersion composition of claim 1 further comprising a salt component, wherein the salt component comprises between 0-25% by volume or weight of the composition.

4. The micronutrient dispersion composition of claim 3, wherein the sugar alcohol component is glycerol.

5. The micronutrient dispersion composition of claim 5, the anionic dispersant component is polyaspartate.

6. The micronutrient dispersion composition of claim 6, wherein the metal or metalloid component includes boron.

7. The micronutrient dispersion composition of claim 6, wherein the viscosity of the micronutrient dispersion is between 3000-9000 cP at room temperature.

8. The micronutrient dispersion composition of claim 7, wherein the specific gravity of the micronutrient dispersion is between 1.4 to about 1.7.

9. The micronutrient dispersion composition of claim 8, further comprising a dimethylpyrazole component, wherein the dimethylpyrazole component comprises between 0-20% by weight of the composition.

10. A fertilizer granule comprising:
a granule component; and
a coating component, wherein the coating component is a micronutrient dispersion comprising:
a sugar alcohol component;
one or more metal or metalloid components;
an anionic dispersant component; and
an anionic surfactant component.

11. The fertilizer granule of claim 11, wherein the sugar alcohol component comprises between 25-50% by weight of the micronutrient dispersion composition, the metal component comprises between 1-65% by weight of the micronutrient dispersion composition, the anionic dispersant component comprises between 0.25-2%% by weight of the micronutrient dispersion composition, and the amino surfactant component comprises between 0.25-2%% by weight of the micronutrient dispersion composition.

12. The fertilizer granule of claim 11, wherein the coating component further comprises a salt component, wherein the salt component comprises between 0-25% by weight of the micronutrient dispersion composition.

13. The fertilizer granule of claim 12, wherein the salt component is polyaspartate and the sugar alcohol component is glycerol.

14. The fertilizer granule of claim 13, wherein the granule component is urea.

15. The fertilizer granule of claim 14, wherein the ratio of the coating component to granule component is 1:150 by weight.

16. The fertilizer granule of claim 15, wherein the coating component is configured to increase uptake of micronutrients into the plants and agglomeration between granules.

17. The fertilizer granule of claim 16, wherein the coating component has a viscosity between 3000-9000 cP at room temperature and a specific gravity between 1.4 to about 1.7.

18. The fertilizer granule of claim 17, wherein coating component of the fertilizer granule has between 1-5% by weight boron, 2-6% manganese by weight, and 4-8% zinc by weight.

19. A method for applying a sugar-alcohol micronutrient as a fertilizer, comprising:
preparing a micronutrient dispersion, wherein said micronutrient dispersion includes a sugar alcohol component, one or more metal or metalloid components, an anionic dispersant component, and an anionic surfactant component;
supplying fertilizer granules;
applying the micronutrient dispersion to the fertilizer granules;
mixing the fertilizer granules and micronutrient dispersion in a mixer until the micronutrient dispersion has coated the fertilizer granules and are dry and free from excess moisture; and
applying the coated fertilizer granules to soil.

20. The method of claim 19, wherein the ratio of micronutrient dispersion applied to the fertilizer granules is between 1:50 and 1:350.
